(19) United States
(12) Patent Application Publication
(10) Pub. No.: US 2003/0169041 A1
(43) Pub. Date: Sep. 11, 2003

(54) Quantum computing integrated development environment

(75) Inventors: Michael D. Coury, Vancouver (CA); Geordie Rose, Vancouver (CA); Jeremy P. Hilton, Vancouver (CA)

Correspondence Address: Pennie & Edmonds, LLP, 3300 Hillview Avenue, Palo Alto, CA, 94304, US

(73) Assignee: D-Wave Systems, Inc.

(21) Appl. No.: 10/326,017

(22) Filed: Dec. 18, 2002

Related U.S. Application Data
(63) Continuation-in-part of application No. 10/028,891, filed on Dec. 22, 2001.

(51) Int. Cl. G01V 3/00

(52) U.S. Cl. 324/307; 324/312

(57) ABSTRACT

A computer program product for use in conjunction with a computer system, the computer program product comprising a computer readable storage medium and a computer program mechanism embedded therein. The computer program mechanism comprises a quantum computing integrated development environment (QC-IDE) module and a compiler module. The QC-IDE module is used to design a quantum logic for a plurality of qubits. The QC-IDE module includes instructions for generating a time resolved set of operators. The compiler module includes instructions for compiling the time resolved set of operators into a set of quantum machine language instructions.

### CROSS REFERENCE TO RELATED APPLICATIONS

This application is a continuation-in-part of U.S. patent application Ser. No. 10/028,891 filed on Dec. 22, 2001, which is incorporated herein, by reference, in its entirety.

### 1.0 FIELD OF THE INVENTION

The invention relates to quantum computers and to methods and apparatus for simulating the operation of a quantum computer.

### 2.0 BACKGROUND

### 2.1 Qubits

A quantum bit or qubit is the building block of a quantum computer in the same way that a conventional binary bit is a building block of a classical computer. The conventional binary bit always adopts the values 0 and 1. The values 0 and 1 can be termed the basis states of a conventional bit. A qubit is similar to a conventional binary bit in the sense that it can adopt basis states as well. The basis states of a qubit are referred to as the |0> basis state and the |1> basis state. During quantum computation, the state of a qubit is defined as a superposition of the |0> basis state and the |1> basis state. This means that the state of the qubit simultaneously has a nonzero probability of occupying the |0> basis state and a nonzero probability of occupying the |1> basis state. The ability of a qubit to have a nonzero probability of occupying a first basis state (|0>) and a nonzero probability of occupying a second basis state (|1>) is different from a conventional bit, which always has a value of 0 or 1.

Qualitatively, a superposition of basis states means that the qubit can be in both basis states |0> and (|1>) at the same time. Mathematically a superposition of basis states means that the overall state of the qubit, which is denoted |Ψ>, has the form

|Ψ>=α|0>+β|1>

where α and β are probability amplitudes. The terms α and β each have real and imaginary components. Typically, when the state of a qubit is measured (e.g., read out), the quantum nature of the qubit is temporarily lost and the superposition of basis states collapses to either the |0> basis state or the |1> basis state, thus regaining its similarity to a conventional bit. The actual state of the qubit after it has collapsed depends on the probability amplitudes α and β immediately prior to the readout operation.

For discussion of qubit operations and control systems for performing quantum computation, see U.S. patent application Ser. No. 09/872,495, “Quantum processing system and method for a superconducting phase qubit,” filed Jun. 1, 2001, which is hereby incorporated by reference in its entirety.

### 2.1.1 Flux Qubits

A number of physical implementations of qubits exist. One such proposal is a superconducting flux qubit. See Mooij et al., 1999, Science 285, 1036, which is hereby incorporated by reference in its entirety. The flux qubit consists of an internal superconducting loop that includes three or more Josephson junctions, inductively coupled to an external dc-SQUID that includes two Josephson junctions. The dc-SQUID has leads through which a bias current can be driven. The bias current through the leads provides a basis for operating on the inner loop, which forms the qubit.

The Mooij qubit can be biased to adjust the energy-phase profile. This DC bias or flux bias adjusts the relative values of a double well of the energy phase profile that describes the qubit. Coupling of flux qubits can be accomplished using inductive coupling that leads to sigma x and sigma z interactions between respective qubits in the Hamiltonian of the quantum system that describes the coupled flux qubits. Direct inductive coupling can be used to couple flux qubits. See, for example, Makhlin et al., 2001, Rev. Mod. Phys. 73, 357, which is hereby incorporated by reference in its entirety.

### 2.1.2 Charge Qubits

An example of a charge qubit is the superconducting electron box proposed by Shnirman and Schön, 1998, Phys. Rev. B 57 15400. The box consists of a superconducting island connected by a Josephson junction to a superconducting electrode with capacitive coupling C to a gate electrode. A control voltage V_{X} is applied using a gate capacitor. The Josephson junction is characterized by the Josephson energy E_{J} (which is related to the Josephson critical current Ic by E_{J}=I_{C}ΦO/2π, and ΦO≡h/2e is the flux quantum) and by the capacitance C_{J} which determines the charging energy scale. In this system, charge in the box and phase across the junction are cannonically conjugated variables. The system will decohere if it is not superconducting, i.e. currents are kept below Ic. The bit states are pseudo spin variables that correspond to charge states |↓>=|n> and |↑>=|n+1>, where n is an integer number of Cooper pairs.

### 2.1.3 Electrons on Helium

Another qubit is “electrons on helium”. The electrons of this class of qubit behave like artificial single electron atoms governed by the Bohr model. The wave functions of the first and second excited state are the bit states of the qubit. The first and second excited states in this type of qubit are not degenerate (i.e., they do not have the same energy). A vertical potential well V(z) α−1/z confines the electrons. The system has analogous behavior to atomic models with its own Rydberg constants and Bohr radius, a_{B} that depends on the isotope of helium used. The system is therefore analogous to a well studied model in mathematical physics. There is an energy transition from the first state with expectation value <zₒ>=1.5 a_{B} to the expected vertical position of the second state <z₁>=6 a_{B}. The energy difference is fᵣ=(E₁−E₀)/h in frequency units. Therefore, pulses like those used in NMR studies can be used to elevate the state of these individual artificial atoms. The electrons would be arranged in an artificial crystal structure called a Winger crystal. Each atom would be addressable, allowing the tuned pulse to interact with the atoms. The qubit-qubit interactions are described by a Hamiltonian that has terms proportional to all the Pauli matrices and their complex linear combinations. The qubit-qubit interaction is always on and is only modulated by range. See Lea et al. and Dykman et al. in Braunstein and Lo (Eds.), 2001, Scalable Quantum Computers, Wiley-VCH Berlin, which is hereby incorporated by reference in its entirety.

### 2.2 Quantum Computing

### 2.2.1 Quantum Computing Defined

Research on what is now called quantum computing traces back to Richard Feynman. See, e.g., Feynman, 1982, Int. J. Theor. Phys. 21, 467, which is hereby incorporated by reference in its entirety. Feynman noted that quantum systems are inherently difficult to simulate with classical (e.g., conventional, non-quantum, digital) computers, but that this task could be accomplished by observing the evolution of a quantum system under controlled circumstances. Solving a theory for the behavior of a quantum system commonly involves solving a differential equation related to the system's Hamiltonian. Observing the behavior of the system provides information regarding the solutions to the equation.

Quantum computing efforts were initially concentrated on building the formal theory or on “software development” or extension to other computational problems. Discovery of the Shor algorithm and the Grover algorithm were important milestones in quantum computing. See, e.g., Shor, 1997, SIAM J. of Comput. 26, 1484; Grover, 1996, Proc. 28th STOC, 212 (ACM Press, New York); and Kitaev, LANL preprint quant-ph/9511026, each of which is hereby incorporated by reference in their entireties. The Shor algorithm permits a quantum computer to factorize large natural numbers efficiently. Using the Shor algorithm, a quantum computer could render obsolete all existing “public-key” encryption schemes. In another application of the Shor algorithm, quantum computers (or even a smaller-scale device such as a quantum repeater) could enable absolutely safe communication channels where a message, in principle, cannot be intercepted without being destroyed in the process. See, Briegel et al., preprint quant-ph/9803056, which is hereby incorporated by reference in its entirety. Showing that fault-tolerant quantum computation is theoretically possible opened the way for attempts at practical realizations. See, e.g., Knill et al., 1998, Science 279, 342.

Quantum computing generally involves initializing the states of N quantum bits (qubits), creating controlled entanglements among them, allowing these states to evolve, and reading out the qubits after the states have evolved. Therefore, qubits are the fundamental building blocks of a quantum computer. As described above, a qubit is conventionally a system having two degenerate (i.e., of equal energy) quantum states, with a non-zero probability of being found in either state. Because of this non-zero probability, N qubits can define an initial state that is a combination of 2^{N} classical states. This initial state undergoes an evolution, governed by the interactions that the qubits have among themselves and with external influences. This evolution of the states of N qubits defines a calculation or in effect, 2^{N} simultaneous classical calculations. Reading out the states of the qubits after evolution is complete determines the results of the calculations.

### 2.2.2 Basic Requirement for Realizing Quantum Computing

The ability of a qubit to adopt a superposition of its basis states is one basis for the power harnessed by a quantum computer. However, in order to be useful in a quantum computer, the qubit must be combined with other qubits to form a quantum register. In fact, the capacity for a quantum register to represent information grows exponentially with the number of qubits in the quantum register. The computing power and nature of quantum computers are known and described in the art. See, e.g., Shor, U.S. Pat. No. 5,768,297, which is hereby incorporated by reference in its entirety.

In addition to the requirement of combining qubits into a quantum register, DiVincenzo sets forth a number of requirements necessary to realize a physical system that is capable of quantum computation. See DiVincenzo, in Scalable Quantum Computers, chapter 1, 2001, Wiley-VCH Verlag GmbH, Berlin, which is hereby incorporated by reference in its entirety. These requirements include the need to initialize the state of the qubits to a simple fiducial state, the need for long relevant decoherence times, a “universal set” of quantum gates, and qubit-specific measurement capability.

### 2.2.3 The Universal Set of Quantum Gates Requirement

As discussed in Section 2.2.2, above, any physical system capable of quantum computation must provide a universal set of quantum gates so that the state of each qubit in the physical system can evolve in a controlled manner. The minimum set of gates required to realize a universal set of quantum gates is set forth by DiVincenzo in Scalable Quantum Computers, Wiley-VCH, Berlin, 2001, Braunstein and Lo, eds. In brief, a universal set of quantum gates includes single qubit operations as well as at least one two-qubit operation.

A single qubit can be considered a vector |Ψ>=a|0>+b|1> parameterized by two complex numbers, a and b, satisfying |a|²+|b|²=1. Operations on a qubit must preserve this norm, and thus such operations are described by 2×2 matrices. Some 2×2 matrices are the Pauli matrices

$${σ}_{1} ≡ {σ}_{x} ≡ X ≡ [ \begin{matrix}0 & 1 \\ 1 & 0\end{matrix} ]$$

$${σ}_{2} ≡ {σ}_{y} ≡ Y ≡ [ \begin{matrix}0 & - i \\ i & 0\end{matrix} ]$$

$${σ}_{3} ≡ {σ}_{z} ≡ Z ≡ [ \begin{matrix}1 & 0 \\ 0 & - 1\end{matrix} ]$$

The Pauli matrices σₓ, σ_{y}, and σ_{z} are three single-qubit operations. For more information on gates, see Nielsen and Chuang, 2000, Quantum Computation and Quantum Information, Cambridge University Press, Cambridge, UK which is hereby incorporated by reference in its entirety.

### 2.2.4 Set of Matrices Available for a 2-Qubit Quantum Computing System

FIG. 4 illustrates the set of matrices available for a 2-qubit quantum computing system, including the possible states of the quantum register. Matrix 400 illustrates the possible states of the 2-qubit system as correlated with standard binary notation. The quantum register can simultaneously exist in a superposition of each of the states, having some complex probability γ₀, γ₁, γ₂, and γ₃ of being in each of the states, respectively. Matrices 410 and 411 represent the matrices of the X operator acting on the first and second qubits in a quantum register respectively. Matrices 420 and 421 represent the matrices of the Z operator acting on the first and second qubits in a quantum register, respectively. Matrices 430 and 431 represent the matrices of the Y operator acting on the first and second qubits in a quantum register, respectively. Matrix 440 represents the matrix of the coupling operator acting to couple the first and second qubits in the quantum register, wherein the coupling operation represents a controlled phase operation. In an N qubit quantum register, these matrices can be scaled to become 2^{N}×2^{N} matrices acting on the corresponding qubit or qubits.

### 2.3 Physical Systems for Performing Quantum Computing

Several physical systems have been proposed for the qubits in a quantum computer. One qubit system uses molecules having degenerate nuclear-spin states. See U.S. Pat. No. 5,917,322 to Gershenfeld and Chuang, which is hereby incorporated by reference in its entirety. Nuclear magnetic resonance (NMR) techniques can read the spin states. These systems have successfully implemented a search algorithm. See, e.g., Mosca, 1998, Nature 393, 344, which is hereby incorporated by reference in its entirety. See also the number-ordering algorithm of Vandersypen et al., preprint quant-ph/0007017 which is hereby incorporated by reference in its entirety. The number-ordering algorithm is related to the quantum Fourier transform, an important element of both Shor's factoring algorithm and Grover's algorithm for searching unsorted databases. Further proposals for physical systems for quantum computing are described above in Section 2.1.

### 2.4 Quantum Computing Programming Languages

Proposals for quantum computing programming languages and architectures have been made. See, e.g., Bettelli et al., 2001, “Toward an architecture for quantum programming”, LANL cs.PL/0103009 v.2, which is hereby incorporated by reference in its entirety. Bettelli et al. investigates a possible approach to the problem of programming quantum computers. The reference provides a template high level quantum language that complements a generic general purpose classical language with a set of quantum primitives. The underlying scheme involves a run-time environment that calculates the byte-code for the quantum operations and sends it to a quantum device controller or to a simulator.

Bettelli et al., however, fails to address the complexities related to the different physical embodiments of quantum computers, and thus does not teach reduction of quantum computing instructions to the byte-code level that is needed in order to control a quantum computer. Furthermore, although Bettelli et al. recognizes that a high level quantum language must allow an automated scalable procedure for translating and optionally optimizing the high level code down to a sequence of low level control instructions for quantum machines, such a scalable procedure is not taught in the paper. Furthermore, the Bettelli et al. high level language is merely abstract. It provides no details on how such a language would work with actual physical systems. In summary, Bettelli et al. teaches a high level programming language that cannot drive an actual quantum computing system.

Furthermore, current quantum simulators have little basis in any physical quantum computing proposals. See, for example, QuCalc (Paul Dumais, Laboratory for Theoretical and Quantum Computing, University of Montreal). QuCalc is a commonly used Mathematica package (Wolfram Research Inc., Champaign Ill.) that simulates quantum computing operations. QuCalc is based on qualitative quantum computing. However, QuCalc does not consider the constraints, limitations, or characteristics of physical quantum computing systems.

Given the above background, there is a need in the art for a development tool that addresses the physical parameters required to operate quantum computing systems and to optimize instructions that are executed in such systems.

### 3.0 SUMMARY OF THE INVENTION

The present invention provides a quantum computing integrated development environment and methods for designing quantum logic with a plurality of qubits, compiling the quantum logic into a set of quantum machine language instructions, executing the quantum machine language instructions, and outputting the results generated by the execution of the quantum machine language instructions. In contrast to prior art systems and methods, the interface of the present invention allows for the design and testing of quantum computing programs that takes into account the unique characteristics of the scalable quantum device that such programs will be executed on.

Designing quantum logic includes selecting a quantum computing system and designing a sequence of fundamental operators. The set of fundamental operators depends on the choice of quantum computing system. Furthermore, a mechanism for designing quantum logic can include defining a sequence of fundamental operators as an abstract operator (abstract quantum gate) and designing a sequence of abstract operators. In some embodiments of the invention, a mechanism for designing quantum logic includes performing a readout operation, and defining conditional operations that can be executed based on the desired conditions. In one example, a readout operation includes performing a readout operation of one or more qubits in a quantum register. Such readout operations collapse the quantum state of the qubit to a binary equivalent. Conditional behavior can include application of fundamental operators (fundamental gates) or abstract operators (abstract quantum gates) on one or more qubits in the quantum register. The conditional operations can be applied to one or more of the collapsed qubits or non-collapsed qubits.

Designing quantum logic can further include setting driver details for a quantum register. The driver details for the register depend on the choice of quantum computing system. The driver details may include parameters such as the minimum duration for application of fundamental operators or the sharpness of the pulses that can be applied. Designing quantum logic can further include preparing the initial conditions of each of the qubits in the quantum computing system.

Compiling quantum logic to a set of quantum machine language instructions includes collapsing a set of abstract operators into a set of fundamental operators. A mechanism for compiling quantum machine language instructions can further include collapsing a sequence of fundamental operators in accordance with a set of rules for optimizing fundamental operators.

The quantum machine language instructions are executed by a quantum register and are regulated by a control system for interacting with the quantum register. A quantum register includes an array of qubits. The basic operations performed on a quantum register are an initialization operation, evolving the state of the quantum register by application of a set of fundamental operators, and a readout operation. The control system can interact with the quantum register to coordinate and time each of the respective operations, as specified by the quantum machine language instructions. In some embodiments of the invention, the quantum machine language instructions are executed by a simulator of a quantum computing system (quantum computer).

Once execution of said machine language instruction set is complete, the quantum register exists in a quantum superposition of its basis states. Such a superposition can then be collapsed to a single basis state to provide a result to the calculation. The final state of the quantum computing system after execution of the quantum machine language instructions provides the result of the calculation.

Some embodiments of the invention allow a user to choose a desired hardware platform, and then provide tools that will aid in designing machines at the hardware, machine language, logic, and software levels. An embodiment of the invention allows the user to control each of these aspects, providing an “integrated development environment” (IDE) in which all phases of computational engine design may be accomplished.

### 4.0 BRIEF DESCRIPTION OF THE DRAWINGS

FIG. 1 is a system 10 that is operated in accordance with one embodiment of the invention.

FIG. 2 is a flow diagram illustrating interactions amongst components of a quantum computing, integrated development environment, in accordance with some embodiments of the invention.

FIG. 3A is an entity-relationship diagram describing a quantum logic design process, in accordance with some embodiments of the invention.

FIG. 3B is a block diagram illustrating components of an execution portion of a quantum computing, integrated development environment, in accordance with some embodiments of the invention.

FIG. 3C is a block diagram illustrating components of an output portion of a quantum computing, integrated development environment, in accordance with some embodiments of the invention.

FIG. 4 illustrates a collection of fundamental operations associated with a two-qubit quantum system, in accordance with the prior art.

FIG. 5 is a block diagram of a quantum computing, integrated development environment used as a calibration tool for a quantum computing environment, in accordance with some embodiments of the invention.

FIGS. 6A-6B illustrate embodiments of interfaces of the present invention for the circuit and machine language design mode for the quantum computing, integrated development environment.

FIG. 7 illustrates another embodiment of the circuit and machine language design mode for the quantum computing, integrated development environment.

FIGS. 8A-8C illustrate embodiments various aspects of the quantum logic design mode in the quantum computing, integrated development environment.

FIGS. 9A and 9B illustrate two embodiments of a run mode interface.

FIG. 10 illustrates an embodiment of an abstract quantum gate.

Like reference numerals refer to corresponding parts throughout the several views of the drawings.

### 5.0 DETAILED DESCRIPTION OF THE INVENTION

Any sequence of quantum logic can be broken down in terms of fundamental operations or “gates”. For information on gates, see Section 2.2.3, above. Thus, these gates make up an important part of the quantum machine language of the quantum computer, along with instructions for initialization and readout operations. As described in Section 2.2.2, quantum computing systems must provide a basic set of quantum operations, or fundamental operators, which are specific to that system. In order to be suitable for quantum computation, a quantum system must be designed to provide σₓ operations, hereinafter referred to as “X” operations, σ_{Z} operations hereinafter referred to as “Z” operations, σ_{Y} operations, herein after referred to as “Y” operations, and an entanglement operation, or a subset of these operations.

One known quantum computing system is nuclear magnetic resonance (NMR). An NMR can achieve all necessary fundamental operations. Other systems that can achieve all necessary fundamental operations include flux qubits, charge qubits, and electrons on Helium. The computational space available for a quantum computation grows with the number of qubits associated with that system as 2^{N}, where N is the number of qubits in the system. Building and designing algorithms for quantum systems is a highly complex task as it involves working with matrices of sizes 2^{N}×2^{N}.

### 5.1 Representative System

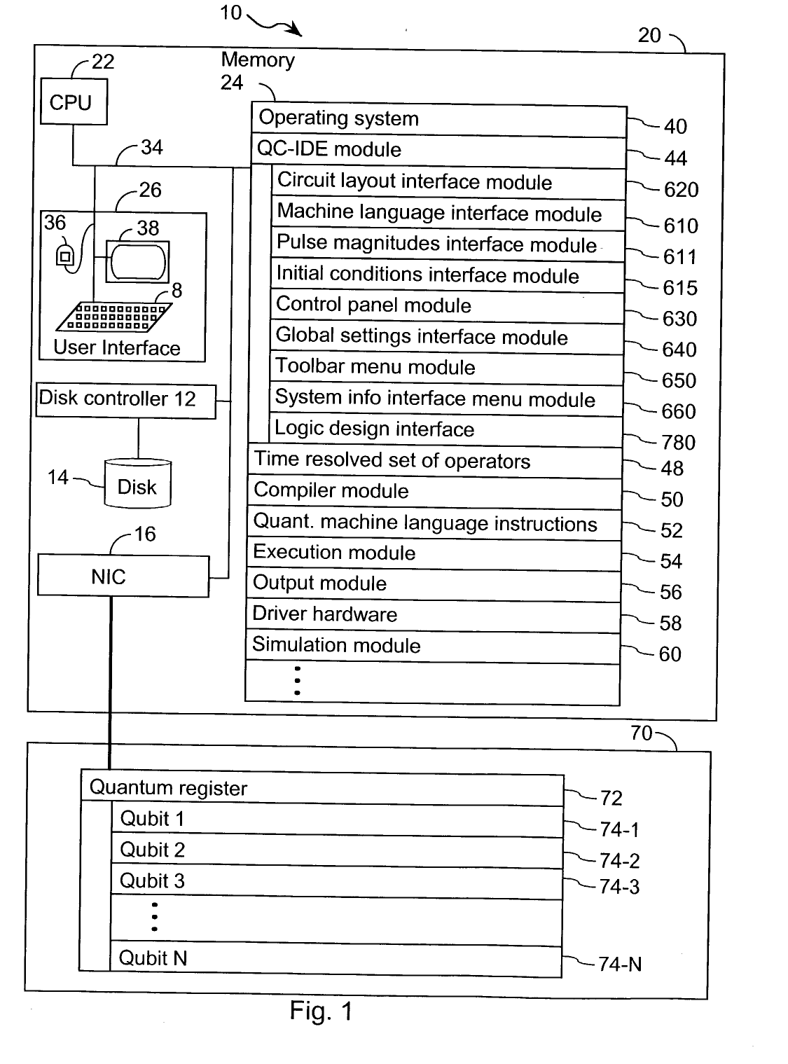

FIG. 1 illustrates a system 10 that is operated in accordance with one embodiment of the invention. System 10 includes at least one digital (binary, conventional) computer 20. Computer 20 includes standard server components including a central processing unit 22, memory 24 (including high speed random access memory as well as non-volatile storage, such as disk storage 14) for storing program modules and data structures, user input/output device 26, a disk controller 12, a network interface card 16 and one or more busses 34 that interconnect these components. User input/output device 26 includes one or more user input/output components such as a mouse 36, display 38, and keyboard 8.

Memory 24 includes a number of modules and data structures that are used in accordance with the present invention. It will be appreciated that at any one time during operation of the system, a portion of the modules and/or data structures stored in memory 24 will be stored in random access memory while another portion of the modules and/or data structures will be stored in non-volatile storage. In a typical embodiment, memory 24 includes an operating system 40. Operating system 40 includes procedures for handling various basic system services and for performing hardware dependent tasks.

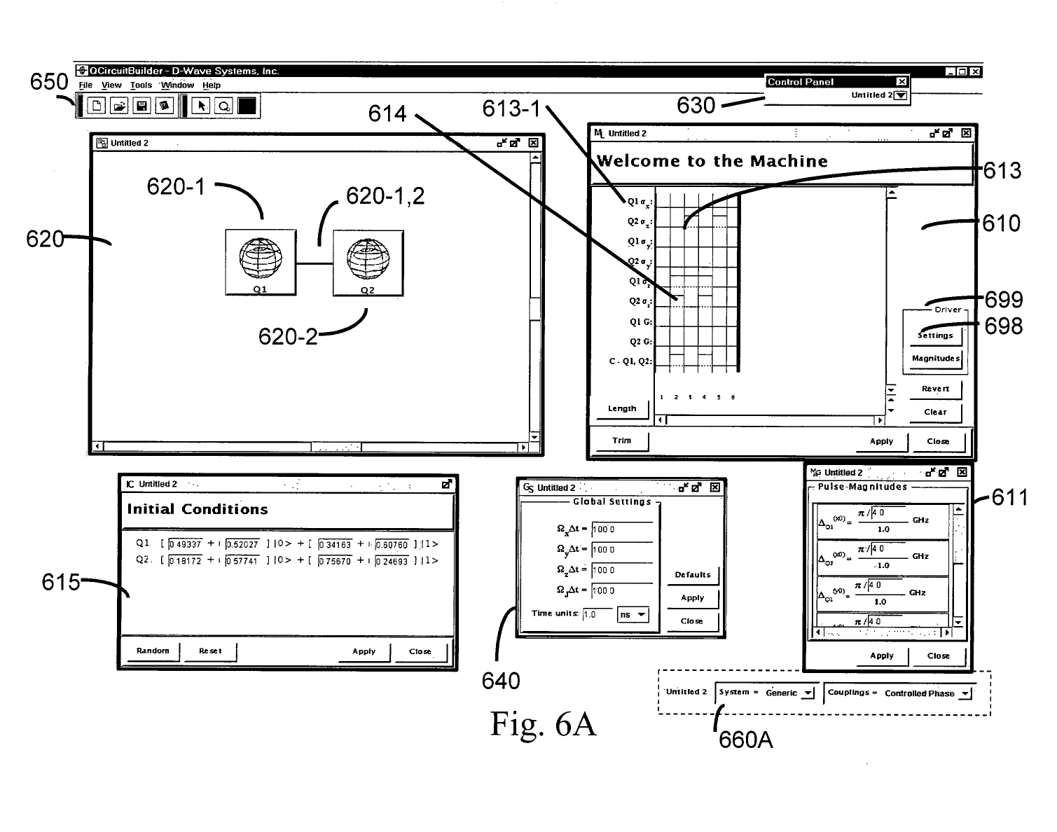

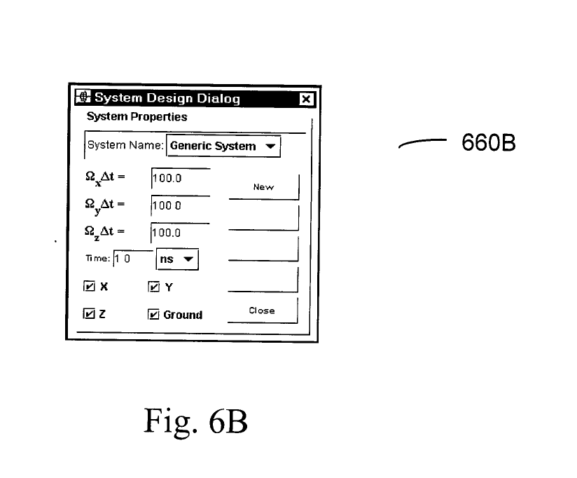

In a typical implementation, the programs and data stored in system memory 24 further include a quantum computing, integrated development environment (QC-IDE) module 44 for designing quantum logic, compiling the quantum logic into quantum machine language instructions, executing the quantum machine language instructions, and providing as output the results of the execution. QC-IDE 44 can be used to develop quantum algorithms, to optimize quantum algorithms, and to perform quantum computation. QC-IDE 44 includes a circuit layout interface module 620, a machine language interface module 610, a pulse magnitudes interface module 611, an initial conditions interface module 615, a control panel module 630, a global settings interface module 640, a toolbar menu module 650, and a system information interface module 660. These modules will be described in further detail below in conjunction with FIGS. 6 through 8. Some embodiments of QC-IDE 44 are used to model quantum systems such as many-body electron systems, nuclear fusion or nuclear fission, or for modeling protein folding systems and the like. In particular, some embodiments of QC-IDE 44 are useful for modeling the structure of proteins, nucleic acids and other biological macromolecules in solution as well as determining interaction energies between such macromolecules and organic compounds. Memory 24 further includes at least one time resolved set of operators 48 that are produced using QC-IDE module 44. The time resolved set of operators 48 is compiled by compiler module 50 form machine language instructions 52 which are then executed by execution module 54 and output to a device by output module 56.

System 10 further includes a quantum computing system 70 that includes a quantum register 72. The quantum register, in turn, contains a plurality of qubits 74. A control system for implementing the fundamental operations on each of the qubits in the quantum register, and a control processor for coordinating the operations is required. In system 10, such coordinating functionality is provided as driver hardware 58 in computer 20.

Although only one quantum computing system 70 is illustrated in illustrated system 10, in practice, system 10 may have any number of quantum computing systems 10. Further, there is no requirement that each quantum computing system 70 in system 10 have the same type of qubits or architecture. For example, some quantum computing systems 70 in system 10 may include one or more quantum registers 72 that include flux qubits 74 while other quantum computing systems 70 in system 10 may include one or more quantum registers 72 that include charge qubits 72. Further, some quantum computing systems 70 in system 10 may include one or more quantum registers 72 that are hybrid registers, for example, including both flux qubits and charge qubits. Driver hardware 58 is used to track the characteristics of each of the quantum computing systems 70 used in system 10, as described in further detail below.

### 5.2 Process Flow

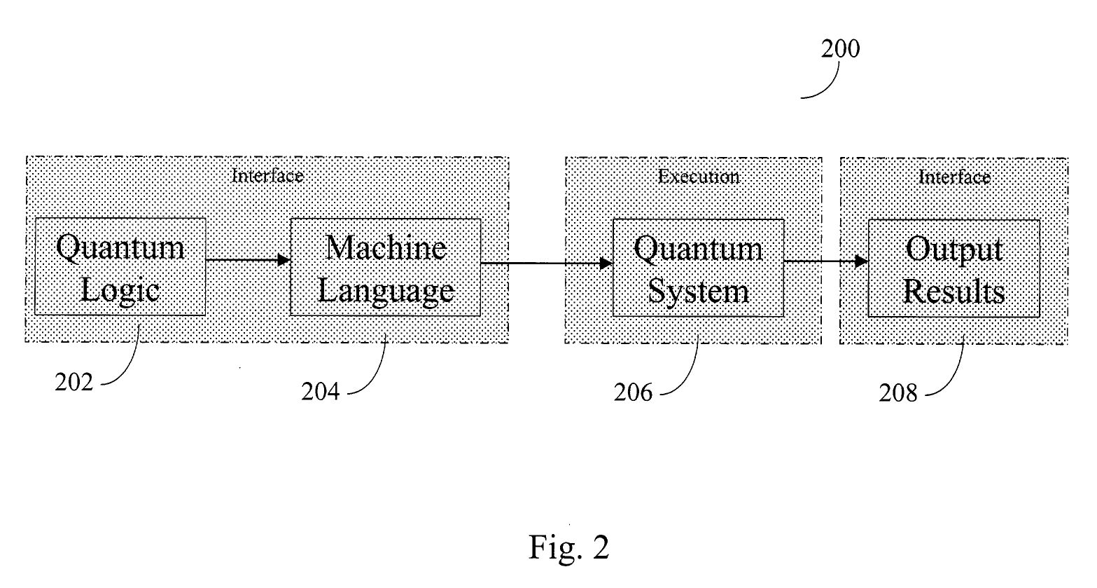

FIG. 2 is a flow diagram of an embodiment of the invention. Quantum logic design is derived in design stage 202 using QC-IDE 44. This results in the production of a time resolved set of operators 48 that are described in further detail below. In compilation stage 204, the quantum logic derived in design stage 202 (time resolved set of operators 48) is compiled by compiler module 50 into a sequence of quantum machine language instructions 52. Instructions 52 may include classical machine language instructions that can be executed by a classical (e.g. digital, computer 20) computer, but typically include at least one quantum machine language instruction capable of execution on quantum computing system 70 (FIG. 1). In execution stage 206, instructions 52 are executed in a quantum computing system 70 and/or computing system 20. Finally, in output stage 208, the results of the calculation are provided as output by output module 56.

Quantum computing logic that is derived in design stage 202 can be defined as a sequence of unitary transformations acting on a quantum state. The fundamental operations of quantum computing logic include the set of quantum unitary transformations that a quantum computer can implement. Generally, the fundamental operations consist of X, Y, Z, and an entanglement operation. In some embodiments, a ground or readout operation is included.

In some embodiments, methods for designing quantum logic during design states 202 include creating a time-resolved sequence of fundamental operators 48, such that the combination, when applied to the initial state of quantum system 70, evolves the initial state of quantum system 70 to some final state. In some embodiments, methods for designing quantum logic include obtaining the output results 208 illustrated in FIG. 2, adjusting the sequence of fundamental operators 48 as required, and iterating the process illustrated in FIG. 2 until the desired quantum logic has been implemented.

In accordance with some embodiments of the present invention, designing quantum logic 202 includes controlling the characteristics of driver hardware 58. Driver hardware 58 is a control system for implementing the fundamental operations on each of the qubits in the quantum register. Driver hardware 58 includes a time unit setting for defining the resolution or minimum duration of each operation in the time resolved set of operators 48. Further, the sharpness of the pulses in the time resolved set of operators 48 can be calibrated in accordance with the characteristics of driver hardware 58. Optimal driver settings ultimately depend on the physical characteristics of quantum computing system 70. For example, U.S. patant application Ser. No. 09/872,495, incorporated herein by reference in its entirety, describes current pulses with a frequency on the order of a gigahertz, and magnitudes on the order of nanoamperes. Such driver settings 58 can be useful for phase or flux qubits, but other physical systems may demand different driver settings.

In some embodiments of the invention, the target quantum computing system 70 can be selected before quantum logic 48 is designed. When a target quantum computing system 70 is selected, the driver hardware 58 details vary according to the requirements of that platform. However, at any point, the driver details 58 for that platform 70 can be modified in order to aid in the design of an algorithm that is executed on the designated quantum computing platform 70.

In some embodiments of the invention, designing quantum logic includes defining the number of qubits 74 required and the possible connections between them (fundamental operators), using QC-IDE module 44. Defining such fundamental operators requires (i) selecting the desired operator sequence, (ii) setting the appropriate driver conditions, (iii) setting the initial state of each of the qubits 74 in the quantum register 72, (iv) compiling the sequence of operations into quantum machine language instructions 52, (v) executing the quantum machine language instructions 52 on quantum computing system 70, and (vi) assessing the result of the executed sequence of operations using output module 56. If the output from the calculation does not satisfy the desired output, the process is repeated by iteratively re-designing the pulse sequence 48 using QC-IDE module 44 until the desired results are obtained.

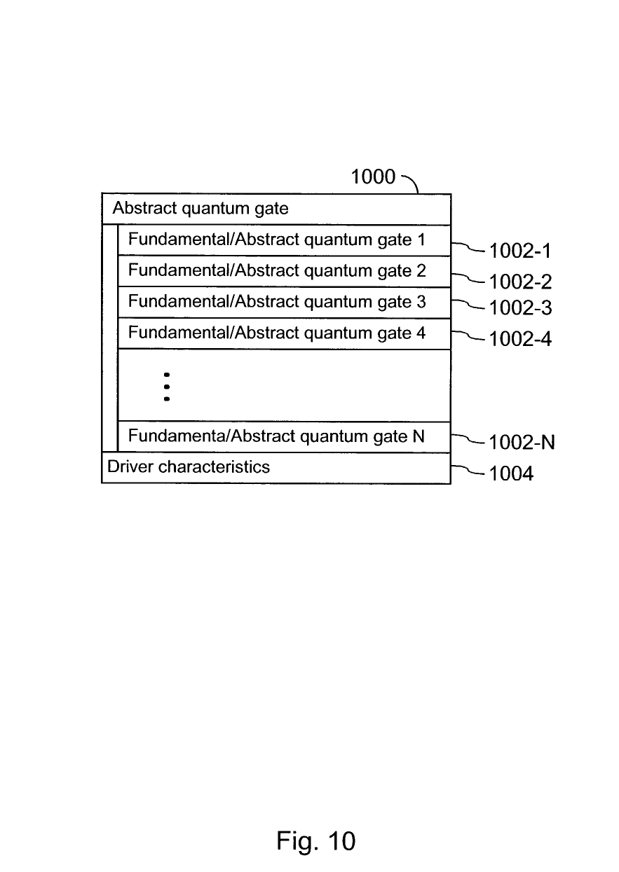

In some embodiments of the present invention, quantum logic 48 includes one or more abstract quantum gates 1000 (FIG. 10). Each abstract quantum gate 1000 includes a sequence of fundamental operations (gates) 1002 and driver characteristics 1004. An abstract quantum gate 1000 can be used to design high-level quantum logic 48. As a sequence of fundamental operations (gates), each abstract quantum gate 1000 can be combined with other abstract quantum gates 1000 to form a sequence of abstract quantum gates, thereby achieving high-level quantum logic 48. In other words, each operation 1002 in an abstract quantum gate 1000 can be a fundamental operation (gate) or an abstract quantum gate.

Some embodiments of the invention include creating abstract quantum gates 1000, and designing high level quantum logic 48 that includes a sequence of abstract quantum gates 1000. An abstract quantum gate 1000 can act upon a single qubit 74 or a plurality of qubits 74. In some embodiments, an abstract quantum gate 1000 includes a sequence of abstract quantum gates 1000. This is particularly advantageous for designing complex quantum logic 48 that involves many qubits 74.

In some embodiments of the invention, an abstract quantum gate 1000 is designed by building the desired sequence of fundamental operators (e.g., the Pauli matrices described in Section 2.2.3, above) and exporting the sequence as an abstract quantum gate 1000. Building a sequence of fundamental operators (gates) can be accomplished using QC-IDE module 44. Once a sequence of fundamental operators (gates) 1002 has been designed, the sequence can be defined as a single abstract gate 1000. In some embodiments of the present invention, an abstract quantum gate 1000 can then be used with a high-level quantum logic design tool.

In some embodiments of the invention, memory 24 includes one or more libraries of abstract operators 1002 (not shown). Abstract operators 1000 in such libraries may be incorporated into a time resolved set of operators 48 during design stage 202. Each library of abstract operators corresponds to a particular target quantum computing system 70. In this way, a library of abstract operators can be used to define the characteristics of a given quantum computing system 70. As a result, a quantum computing system 70 in system 10 can simulate another quantum computing system accurately.

### 5.2 Introducing Conditional Steps into Quantum Logic

One aspect of the present invention provides quantum logic 48 (FIG. 1) that includes a set of conditional actions. These conditions are based on the results of prior readout operation of a single qubit 74 or a plurality of qubits 74. A readout of a qubit 74 involves collapsing the state of the qubit such that the qubit returns a classical “1” or “0” and then measuring the value (0 or 1). This aspect of the invention is advantageous because quantum algorithms often require conditional actions that are based on the readout of a single qubit 74 or a plurality of qubits 74. See, for example, U.S. Pat. No. 5,768,297 to Shor, which is hereby incorporated by reference in its entirety. Error decoding operations typically involve reading out the state of certain ancillary qubits 74 and performing operations on other qubits based on those measurements in order to remove possible error from the information. Further, readout and subsequent conditional behavior is typically used for quantum teleportation. In U.S. Pat. No. 5,768,297, decoding a logical quantum state requires measuring two qubits and then performing a NOT quantum operation on a target qubit based on the outcome of the readout of the first two qubits.

In one embodiment in accordance with this aspect of the invention, quantum operations are executed based on the outcome of a prior readout operation (or set of readout operations). This control logic is stored in the time resolved set of logic operators 48. In some embodiments, the readout operation is performed on a plurality of qubits 74 and conditional quantum logic based on the outcome of the readout operation is designed. This conditional logic is applied to a qubit 74 that remains in a quantum state (i.e. to a qubit that has not undergone a readout operation). A set of quantum operations that can be executed based on the readout may include a set of fundamental operators and/or a set of abstract operators 1000, available to the respective quantum computing system 70.

Any fundamental operator, or defined set of fundamental operators, available to QC-IDE 44 module can be used as a basis for conditional logic. To illustrate, an exemplary quantum logic design 48 uses three qubits 74. After some evolution of the set of three qubits 74 has occurred, the second and third qubit are read out. Then, a set of operators are applied, conditional on the result of the readout operations as illustrated by the following pseudocode:

if ((readout of qubit 2 ) and (readout of qubit 3 ) are in bit state 1)

then apply a quantum operation to qubit[1] else

continue without applying any conditional quantum operations.

In some embodiments of the invention, a set of conditional behavior can be defined based on a set of readout operations on qubits 74 in quantum computing system 70.

### 5.3 Compiling the Time Resolved Set of Operators

In order to convert quantum logic, expressed in the form of a set of abstract operators 48, into a set of quantum machine language instructions 52 (FIG. 1), the abstract operations 1002 must first be compiled into an equivalent set of fundamental operators. Compiling quantum logic includes converting a set of abstract operations 1002 into a set of fundamental operations, and incorporating the driver settings into the fundamental operations to create a set of quantum machine language instructions 52.

Converting a set of abstract operators 1000 into a set of fundamental operations includes optimizing the sequence of fundamental operations. Since decoherence processes in quantum computing systems 70 render the time required to execute a calculation of critical importance, optimization of the set of fundamental operations becomes important for execution of the quantum logic. U.S. patent application Ser. No. 09/782,886, which is hereby incorporated by reference in its entirety, describe rules for optimization (reducing) a set of fundamental operators. In some embodiments of the invention, these rules include commutation of fundamental operators, removal of empty time units, and removal of redundant pulse sequences or replacement of such pulse sequences by simplified pulse sequences.

Commutation of fundamental operators allows quantum gates that do not interfere with each other to overlap or change their order in time. For example, an X operation on qubit 74-1, does not interfere with an X operation on qubit 74-2, and the time-resolved sequence X(1)X(2) is the same as X(2)X(1). Commutation operations depend are quantum computing system 70 dependent, since the choice of quantum computing system 70 determines which fundamental operators commute. For example, the effect of a coupling operation between two qubits 74 can depend on the nature of the coupling, and the coupling in turn depends on the quantum computing system 70 used.

Once a desired logic 48 has been developed, it can be defined as an abstract quantum operator for that quantum computing system 70. A set of abstract quantum operators can be used to implement high-level quantum logic such as a quantum Fourier transform (QFT), for example. See, e.g., U.S. patent application Ser. No. 09/782,886 to Blais, which is hereby incorporated by reference in its entirety This high level of quantum algorithm development provides a level of abstraction useful for building such complex quantum algorithms. Further, due to the sensitivity of quantum computing systems to possible errors, individual qubit states can be encoded as logical qubits, wherein a plurality of physical qubits can be used to encode a single qubit state, such that the state is protected from errors during the computation. Such algorithms can include aspects similar to classical error correction algorithms, See, e.g., U.S. Pat. No. 5,768,297 to Shor, which is hereby incorporated by reference in its entirety.

When high level quantum logic 48 is used for design, some lack of efficiency results when a set of abstract operators are directly converted to a set of quantum machine language instructions 52. For example, in U.S. patent application Ser. No. 09/782,886, a controlled not (CN) gate is defined as the following sequence of fundamental operations:

$${CN}_{rs} = {ⅇ}^{- ⅈ \frac{3 π}{4}} {X}_{s} {CP}_{rs} {Z}_{s} {X}_{s} {Z}_{s} {Z}_{r} {CP}_{rs} .$$

Where r and s are two qubits 74 and Z and X are as defined in Section 2.2.3. This pulse sequence consists of fundamental quantum gates that are available in most solid state quantum computing systems. Here, the CPᵣₛ gate is an entanglement operation between two qubits having the effect of a ZᵣZₛ operation. A SWAP₁₂ quantum gate is defined as:

SWAP₁₂=CN₁₂CN₂₁CN₁₂,

thus, by defining the CNᵣₛ operation between two qubits as an abstract operator, the SWAPᵣₛ operator can be further defined as an abstract quantum operator using a sequence of the CNᵣₛ abstract quantum operators. Direct conversion of the sequence described above for the SWAP abstract operator to a sequence of fundamental operators results in some degree of redundancy. Using optimization rules such as commutation of operators, certain simplifications can be automated, in accordance with some embodiments of the invention. For example, the CNᵣₛ illustrated above can be re-sequenced as:

$${CN}_{rs} = {ⅇ}^{- ⅈ \frac{3 π}{4}} {X}_{s} [ {CP}_{rs} {Z}_{s} ] {X}_{s} [ {Z}_{s} {Z}_{r} {CP}_{rs} ] ,$$

where the square brackets offset the operators that can be performed simultaneously, thus reducing the total required time to execute the CNᵣₛ operation. Similar reductions result from the fundamental operators associated with the SWAP expansion.

In some embodiments of the invention, quantum logic can be designed using fundamental operators of the quantum computing system 70 directly. In this case, QC-IDE module 44 can be used to optimize the set of fundamental operations, and compiling includes combining driver details with the set of fundamental operators to be executed on the quantum computing system 70.

The quantum machine language 52 used in the compilation process can vary depending on the target quantum computing system 70. Different quantum computing systems 70 can have different sets of fundamental operators. A quantum computing system has operators sufficient to form a universal set. Some embodiments of the invention can compile quantum logic in terms of quantum machine language 52 that is specific to a predetermined quantum computing system 70.

### 5.4 Quantum Machine Language Instructions

Once the quantum logic 48 and driver 58 details are compiled, a set of quantum machine language instructions 52 exist that can be executed. The nature of the machine language instructions 52 depend upon the mechanism for executing those instructions. For example, a mechanism for executing the instruction set can be a particular quantum computing system 70, or a simulation of that system resident in memory 24 of digital computer 20. Thus, the set of fundamental operators available varies for each quantum computing system.

A quantum machine language instruction set 52 can be executed on those quantum computing systems 70 described herein. A quantum computing system 70 includes any quantum mechanical system where a set of basis states can be used to compute in accordance with quantum mechanical principles. A quantum system useful for quantum computing must provide at least some degree of control over the information units or qubits 74 of the system. For example, each quantum computing system 70 must be able to initialize the state of a qubit 74, perform a sequence of unitary evolutions of the qubit 74, and perform a readout operation on the state of the qubit 74. Quantum computing systems such as this are termed “quantum registers” 72, where the operations required for quantum computing is applied to a plurality of qubits 74. Quantum register structures 72 are described, for example, in U.S. patent application Ser. No. 09/872,495, which is hereby incorporated by reference in its entirety.

### 5.5 Quantum Logic Design Process

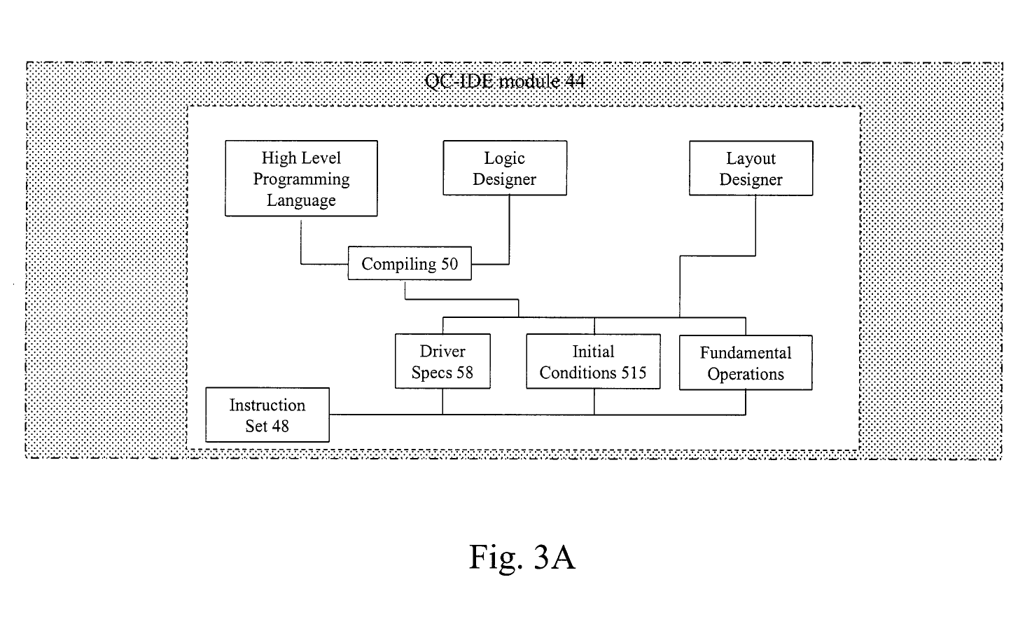

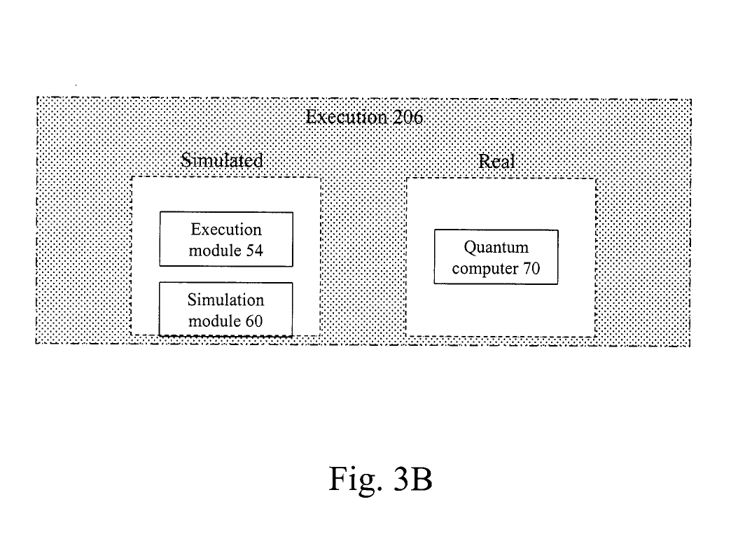

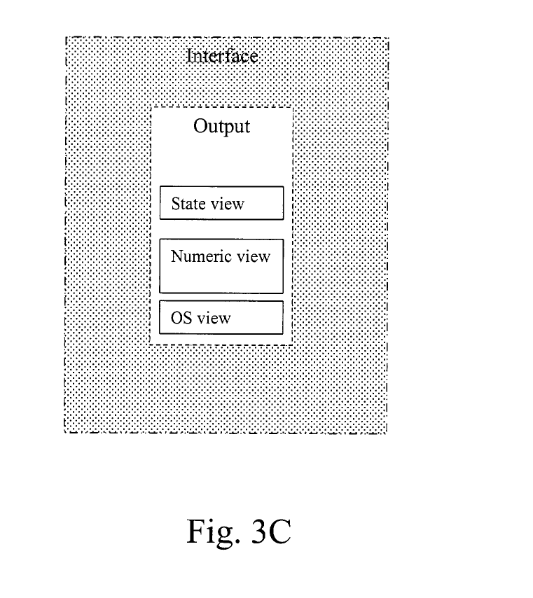

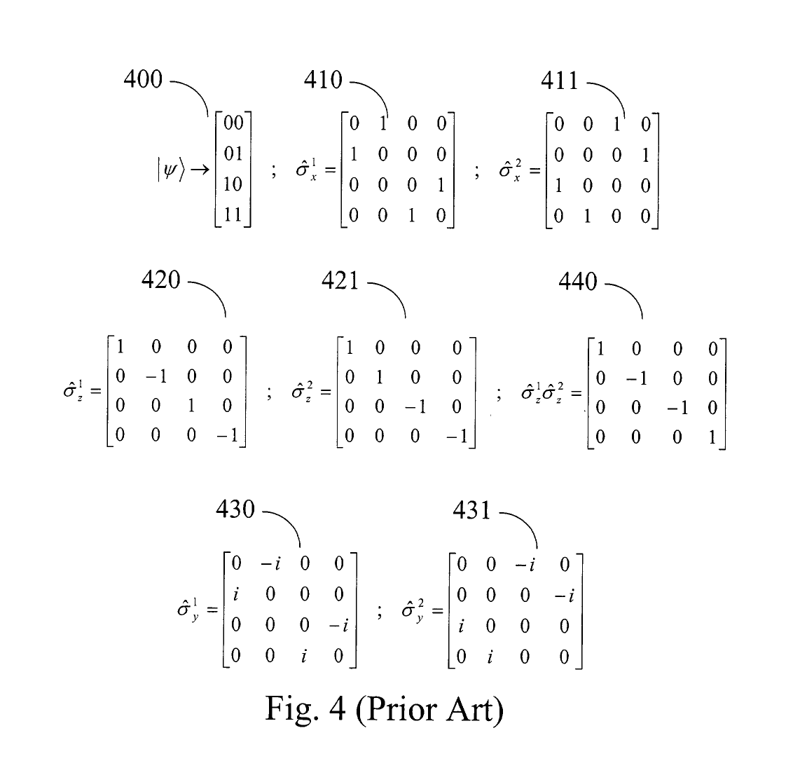

FIGS. 3A, 3B and 3C illustrate quantum logic design processes in accordance with various embodiments of the invention. FIG. 3A illustrates operation sequence design tools found in some embodiments of QC-IDE module 44. These tools include tools for specifying driver details, specifying initial conditions of quantum computing system 70, and compiling an instruction set 48 into an instruction set 52 (FIG. 1). In some embodiments of the invention, the initial conditions of the qubits 74 in the quantum computing system 70 are set to the |0> state by default.

The set of quantum machine language instructions 52 dictates which operations are to be performed in the quantum register 72 in a time-resolved manner. Once compiled, the quantum machine language instructions 52 are executed by a control system (execution module 54) and driver (driver hardware 58), which makes use of the control aspects provided by a quantum register 72, as shown in FIG. 3B. In particular, FIG. 3B shows that instruction set 52 can be simulated on digital computer 20 using simulation module 60. Alternatively, the instruction set 52 can be executed on a quantum computer 70. In some embodiments, simulation module 60 is an ordinary differential equation solver. When simulation module 60 is used, a superposition of states of the quantum computing system are prepared based on input from the initial conditions. Since the initialization operation available in a quantum computer 70 can only initialize a qubit to either the |0> or 51 1> state, initialization to a superposition of states is physically unrealistic. For simulation purposes, however, it is sometimes useful to bypass the initialization process and initialize the quantum computing system directly to a desired state.

FIG. 3C illustrates how the results of the execution of quantum machine language instructions 52 are provided as output. Useful forms of output include the final state of register 72, in terms of classical values, such as 0 or 1. Further, in instances where quantum machine language instructions 52 are simulated using simulation module 60, the evolution of the quantum state of quantum register 72 can be monitored on a plot that compares the normalized magnitudes of the superposition of states. The reason simulation provides more data than actual computation on a quantum computer 70 is that the readout operation on quantum computer 70 collapses the states of qubits 74 into the classical values “0” or “1”. Since no physical readout in required by simulation module 60, there is no need to collapse the quantum states of the simulated qubits and therefore, the matrices that represent such qubits can be output.

In some embodiments of the invention, quantum computing system 70 can only be initialized to a classical state of either |0> or |1>. Thereafter system 70 evolves to a superposition of basis states. In this case, a set of abstract operators are used to provide quantum logic for evolving quantum computing system 70 to a superposition of states useful for the calculation, prior to actually performing the desired quantum calculation.

### 5.6 Simulating a Quantum System on a Classical Computer

As described above, in some embodiments of the present invention a classical computer 20 can be used to design, compile, execute, and provide output for the quantum computing integrated development environment. Thus, in some embodiments of the invention, a quantum computing system is simulated using a classical computer 20.

Embodiments of the invention in which the quantum computing system is simulated include the time-dependent Schrödinger equation (TDSE) in the Hilbert space generated by N two level systems (qubits). A Hilbert space represents all the possible values of one or more qubits. The Hamiltonian of a N qubit system can be represented as:

$$\hat{H} ( t ) = {\sum }_{j = 1}^{N} [ {Δ}_{j}^{( x )} ( t ) {\hat{σ}}_{x}^{j} + {Δ}_{j}^{( y )} ( t ) {\hat{σ}}_{y}^{j} + {ϵ}_{j} ( t ) {\hat{σ}}_{z}^{j} ] + {\sum }_{k < m}^{N} {J}_{km} ( t ) {\hat{σ}}_{z}^{k} {\hat{σ}}_{z}^{m} ,$$

where the first three terms are the Pauli matrices X, Y, and Z, combined with the driver details, Δ and ε respectively, and the last term is a controlled-phase type coupling between qubits k and m. The effect of an entanglement operation depends on the particular embodiment of the invention. The states in the Hilbert space are labeled in the regular binary form, with “qubit 1” always the rightmost digit and “qubit N” always the leftmost.

In some embodiments of the invention, executing machine language instruction set 52 includes simulating a quantum computing system 70. The quantum register in such a simulated environment evolves according to the application of the available set of fundamental operators. As described above, the simulated evolution of a quantum register can be described by solving the time-dependent Schrödinger equation. The Hamiltonian of the system contains all of the time-resolved behavior of the quantum system, including the sequencing of fundamental operators as well as potential sources of error or dissipation, and is represented by a 2^{N}×2^{N} matrix, where N represents the number of qubits in the system. Each of the fundamental operators can be described by a 2^{N}×2^{N} unitary matrix, each of which correlates with a specific evolution of the state of the quantum register.

In some embodiments of the invention, a simulation of a quantum system includes preparing a 2^{N}×2^{N} time-dependent matrix representing the Hamiltonian of the system to be solved, where N represents the number of qubits in the system, and numerically solving the Schrödinger equation using the prepared time-dependent Hamiltonian. A data structure useful for storing the Hamiltonian information can be a “Sparse Matrix” data type in which all elements in the Hamiltonian are stored in a hash table, keyed by matrix entry value by row and column, and each element in the matrix stores the time-dependent complex numbers that represent a fundamental operator that is being applied. Some of the fundamental operators have matrices with entries only along the diagonal. A data structure useful for these fundamental operators can be a “diagonal matrix” data type, where the data type need only maintain information regarding 2^{N} states, which is the number of elements along the diagonal. Since the elements are known to be placed linearly along the diagonal of the matrix, a sparse matrix data structure would reduce efficiency. Thus, the Hamiltonian can be generated by summing each of the matrices for each of the fundamental operators being applied to the system. In some embodiments of the invention, potential sources of decoherence can be taken into account and further incorporated in the Hamiltonian.

### 5.7 Calibrating a Quantum System

Some embodiments of the invention can be used to calibrate a quantum computing system 70. Such embodiments include functionality for (i) initializing a quantum register 72, (ii) evolving register 72 to some superposition of basis states, (iii) evolving the state of quantum register 72, and (iv) reading out the result of the evolution. This functionality is useful for calibrating a single qubit 74 in a quantum register 72. In such a calibration, a qubit 74 is initialized and subsequently read out in order to gather information regarding inherent decoherence processes in the quantum computing system 70. Furthermore, after initialization, a sequence of fundamental operators can be applied to the qubit, before the readout operation is applied. Through a process of repeated measurement, a statistical analysis of that particular qubit 74 in the quantum computing system 70 can be gathered as related to each of the fundamental operations applicable to a single qubit 74 for the given quantum computing system 70. The procedure can be extended to the calibration of a plurality of qubits 74. Furthermore interaction operators between qubits can be calibrated as well using the systems and methods of the present invention.

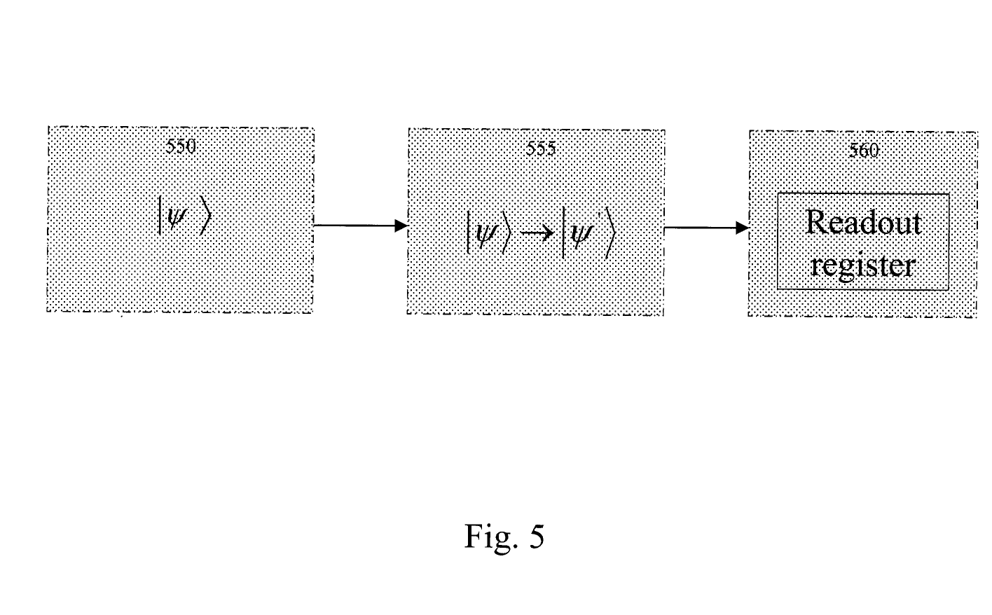

FIG. 5 illustrates an application of the QC-IDE as a calibration tool for a quantum computing environment. State 550 represents the initial state of the quantum register for the calibration. This state depends on the number of qubits 94 involved in the calibration. State 550 represents the initial state of the register as prepared by the control system. Typically, the register can begin in some single classical state rather than in some superposition of states. Evolution of the initial state 550 of the quantum computing system can then be accomplished in operation 555, where some sequence of fundamental operators is used to evolve the state of the quantum computing system. Once the sequence of fundamental operators has been applied, a readout operation 560 can be performed on the quantum computing system. The output from the register can thus be correlated with the input state and sequence of applied fundamental operators to determine information about the quantum system.

### 5.8 The Interface Mode of the QC-IDE

FIGS. 6 through 8 illustrate various aspects of the interface mode of QC-IDE 44 in accordance with one embodiment of the present invention. FIG. 6A illustrates the circuit layout interface module 620, machine language interface 610, pulse magnitudes interface 611, initial conditions interface 615, control panel 630, global settings interface 640, toolbar menus 650, and system information interface 660.

FIG. 6A illustrates an example of a quantum program that implements a 2-qubit quantum CNOT operation. The quantum CNOT operation involves two qubits (620-1 and 620-2). One of the two qubits acts as a control and the other qubit acts as a target. The CNOT operation requires a coupling mechanism 620-1,2 between the respective qubits (FIG. 6A). The circuit illustrated in circuit layout interface module 620 represents a general quantum computing scheme, and can be designed to reflect the physical characteristics of any quantum computing system 70.

Machine language interface 610 in FIG. 6A illustrates an example of a pulse sequence for implementing a quantum CNOT operation. The horizontal axis of chart 613 in interface 610 represents time units, where each number on the horizontal axis represents a successive time period (duration). Each row of chart 613 represents a qubit gate to be applied to a designated qubit. For example, row 613-1 of chart 613 is denoted “Q1σ_{X}”. This means a σ_{X}gate is applied to qubit 74-1 at each time period in which a pulse appears in row 613-1 in chart 613. A pulse is represented by a raised vertical line in a given row at a given time period. For example, there is a pulse in time period 2 in row 614 of chart 613. This means that a σ_{X} gate is to be applied to qubit 74-2 during time period 2. In the example of FIG. 6A, the CNOT operation is represented as follows:

CNOT_{1,2}=e^{i3π/4}X₂(π/2)C_{1,2}(π/2)Z₂(π/2)X₂(π/2) Z₂(π/2)Z₁(π/2)C_{1,2}(π/2),

where Xᵣ(θ) represents a single qubit bit-flip operation applied to qubit r for a phase θ, Zᵣ represents a single qubit phase operation applied to qubit r for a phase θ, C_{r,s}(θ) represents a two-qubit controlled phase operation, which entangles the states of qubits r and s again over a phase θ, and e^{i3π/4} represents a global phase.

The implementation and optimization of the quantum CNOT operation will now be described above in detail. The rows in chart 613 represent, from the top, Xᵣ(θ), Yᵣ(θ), Zᵣ(θ), ground or readout operations, and C_{r,s}(θ) operations for qubits 1 and 2 respectively. A raised bar in a row indicates that the respective gate is turned on during that time unit, representing a pulse of that operation on the respective qubit. The magnitudes of the pulses can be defined in pulse magnitudes interface 611.

Machine language interface 610 represents the quantum machine language to be executed on quantum computer 70. Once it is compiled, it contains all relevant information that is important for the program to execute. In FIG. 6A, the hardware settings and pulse details can be defined by accessing the “Settings and Magnitudes” buttons 698 in driver panel 699 in machine language interface 610.

The “Settings and Magnitudes” buttons 698 respectively open global settings interface 640 and pulse magnitudes interface 611. Global settings interface 640 allows the user to control the steepness of the applied pulses. The user can also define the time units to work in. Such time units are illustrated in FIG. 6A as 1.0 nano-seconds (ns). Pulse magnitudes interface 611 allows the user to set the default area under the applied pulses, which permits a degree of freedom for the respective quantum gate.

Initial conditions interface 615 permits the user to prepare a desired initial state for quantum system 70 by setting the complex states of each of the qubits 74 respectively. The state of a qubit 74 is defined as |Qᵣ>=α|0>+β|1>, where α and β are complex numbers having the form a+ib, and a and b are real numbers. Referring to FIG. 6A, the initial conditions for qubit Q1 are defined as follows:

Q1:[(0.49337)+i(0.52027)]|0>+[(0.34163)+i(0.6076)]|1>.

Initial conditions interface 615 includes a random button for assigning arbitrary numbers to qubit states. This function is useful in preparing the initial state of quantum register 72 in a superposition of states for understanding the logic of the respective operation.

Toolbar 650 allows the user to access standard features common in software such as “New”, “Open”, “Save”, and “Help”, as well as tools that are specific to QC-IDE module 44 that are useful for circuit layout interface module 620, such as “Cursor”, “Add Qubit”, and ‘Add Connection”.

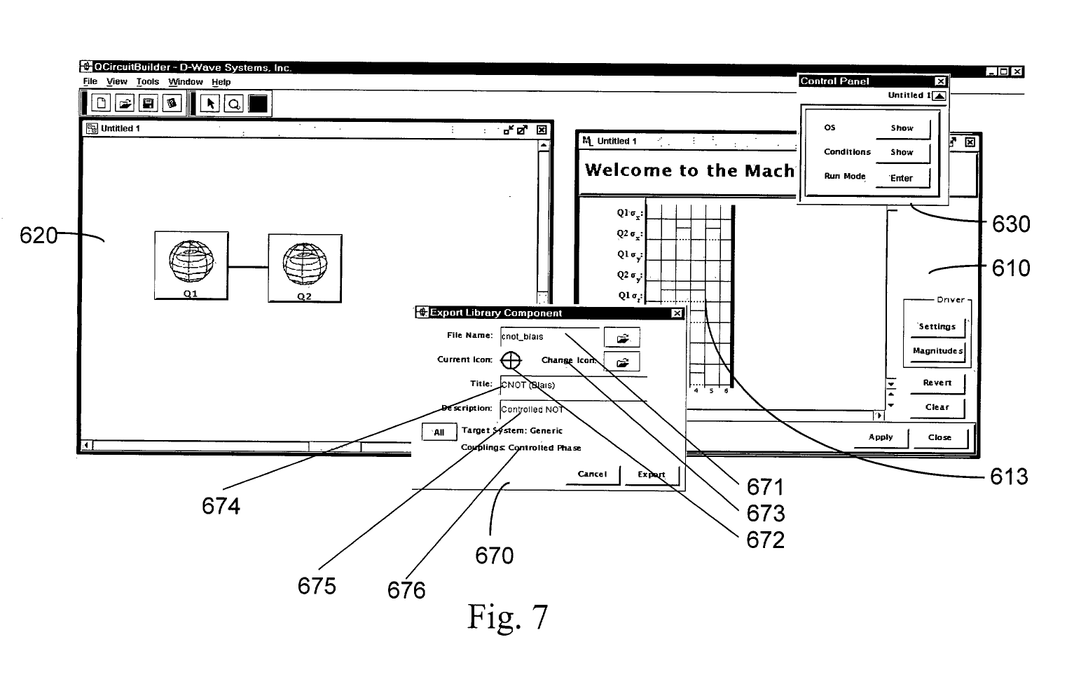

Control panel 630 is an embodiment of an interface for opening and closing the respective interfaces illustrated in FIG. 6A. In an embodiment of the invention, control panel 630 has a closed state, in which it can be reduced in size to expand the visible work space, and an open state, in which the features and controls that it provides are accessible. FIG. 7 illustrates the open state for Control Panel 630.

System information interface 660A (FIG. 6A) includes information about the circuit and logic that is being applied. Interface 660A includes the title of the working document, the system type, illustrated as System=Generic, and the form of coupling, illustrated as Couplings=Controlled Phase. System information interface 660A allows the user to define parameters of the desired quantum computing platform 70. For example, in some cases, the quantum CNOT operation can be chosen for the coupling operations such that Couplings=CNOT.

FIG. 6B illustrates an embodiment of the system design interface 660B. System design interface allows the user to define useful aspects of the system and is related to global settings interface 640 and system information interface 660A from FIG. 6A.

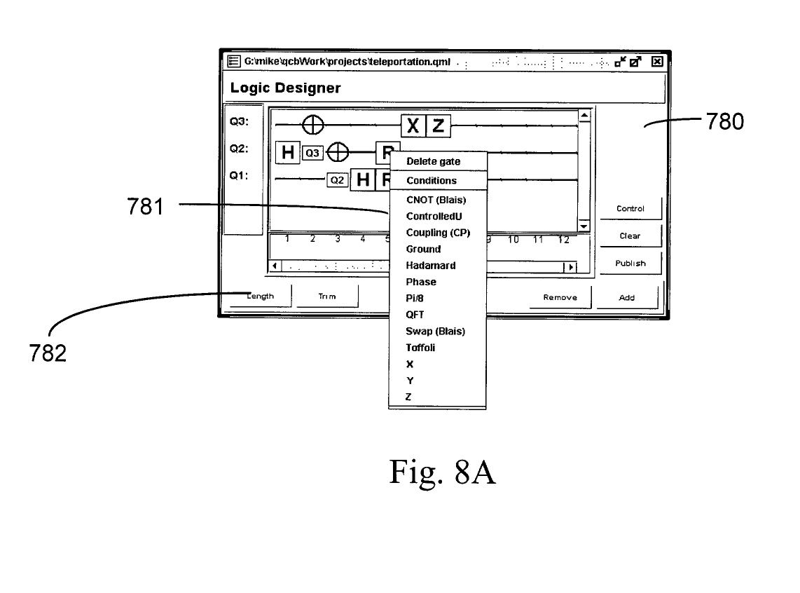

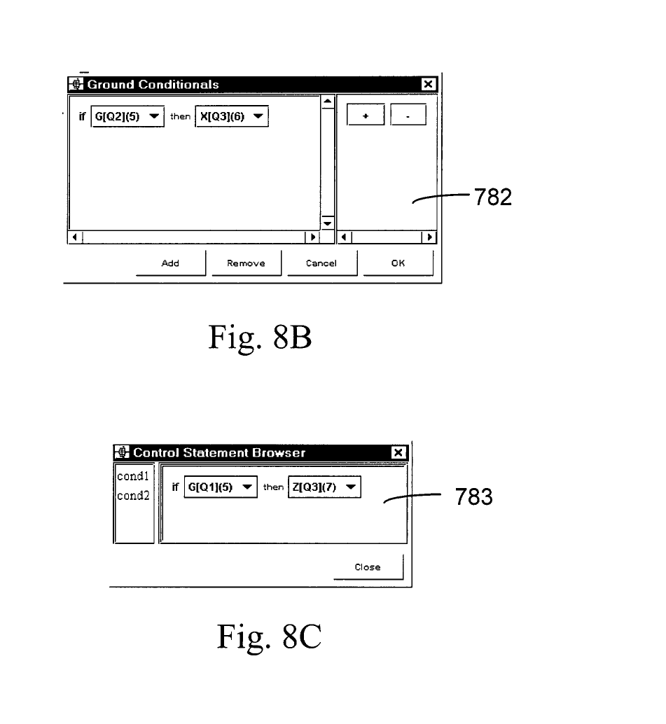

FIG. 7 illustrates an example of the creation of a quantum gate for use in the Logic Design interface of QC-IDE module 44. As illustrated in FIG. 6A, circuit layout interface module 620 and machine language interface 610 are used to define a basic sequence of pulses that implement a set of logic 48 on quantum computer 70. Chart 613 in machine language interface 610 in FIG. 7 illustrates a quantum CNOT operation. FIG. 7 illustrates an example of the export library component interface 670, which is used for defining and exporting a machine language sequence as a single quantum logic gate for use in the logic design interface (an embodiment is illustrated in FIG. 8A). Export library component interface 670 includes a text area 671 for the file name, a display 672 of the icon to be used for the library component, a button 673 for selecting desired icon to be used, a text area 674 for the title of the library component, a text area 675 for describing the library component, and some text 676 that describes the system information for the library component. The library component title, description, and icon can be useful for conveying information in the logic design interface.

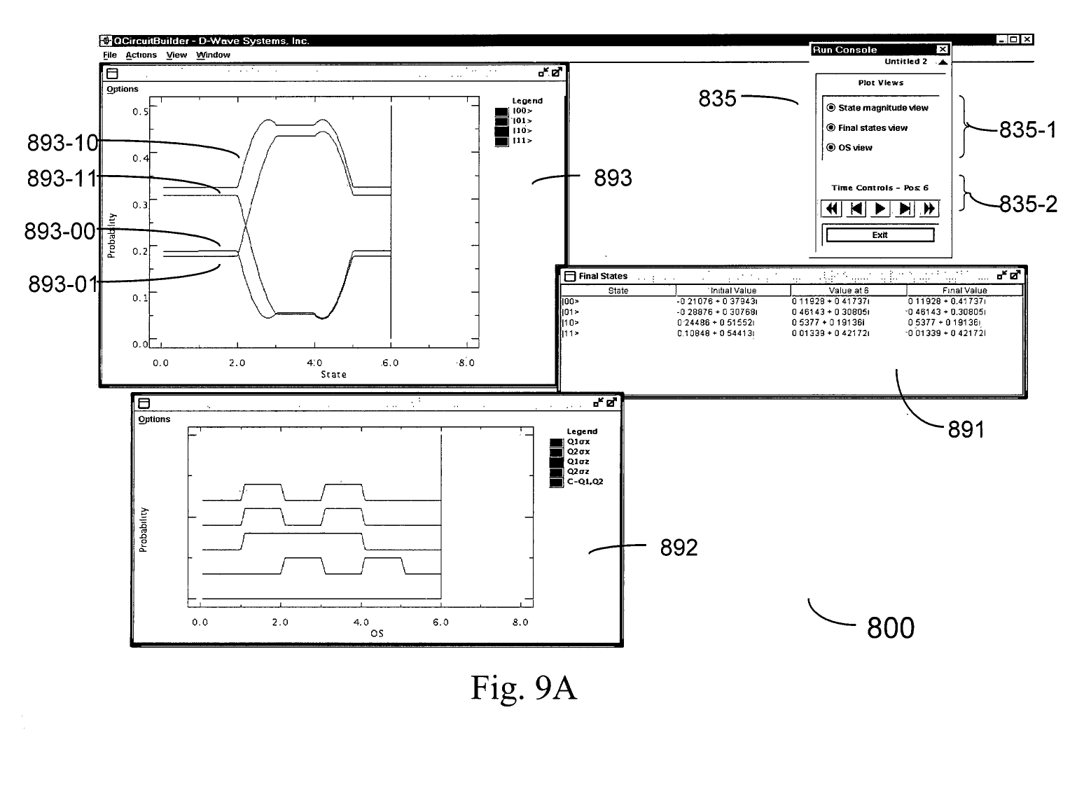

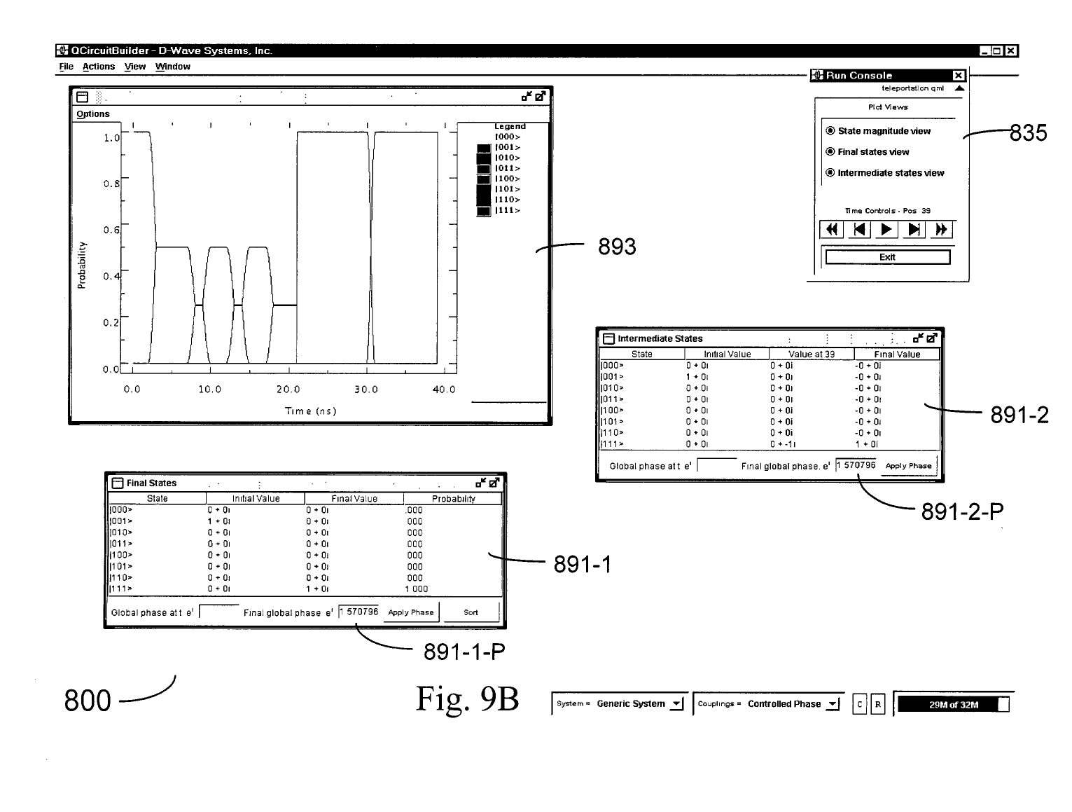

FIG. 7 further illustrates an example of the open mode of control panel 630. The example of control panel 630 illustrated in FIG. 7 includes an OS button, for viewing machine language interface 610, a conditions button for viewing initial conditions interface, 615 from FIG. 6, and a run mode button for compiling, executing, and viewing the results of the respective machine language (an embodiment of the run mode interface is illustrated in FIGS. 9A and 9B).

FIG. 8A illustrates an embodiment of the logic design interface 780. Logic design interface 780 allows the user to design high-level quantum logic using a standard quantum circuit view. The qubits are represented on horizontal rows that represent increasing time from left to right. In some embodiments, quantum logic gates are added to each of the qubit lines by clicking on the respective time step and qubit line. In some embodiments of the invention, by right-clicking the mouse pointer on the respective qubit line at the desired position, a drop-down menu appears displaying a list of library components. An embodiment of a drop down menu 781 that lists the available library components is illustrated in FIG. 8A.

Logic design interface 780 of FIG. 8A illustrates an example of quantum teleportation circuit where the initial state of qubit Q1 is teleported to qubit Q3. The circuit for quantum teleportation is well known in the art. See, e.g., Nielsen and Chuang, 2000, Quantum Computation and Quantum Information, Cambridge University Press, Cambridge UK, p.26-28, which is hereby incorporated by reference. As illustrated, the teleporation circuit comprises a quantum circuit that includes Hadamard and CNOT operations, as well as readout, X, and Z operations.

Referring again to FIGS. 6 and 7, the quantum CNOT operation can include a sequence of elementary pulses or machine language operations. Since a single logic gate in logic design interface 780 can represent a plurality of elementary pulses, a single time unit can also represent a plurality of time units. In some embodiments, a single time unit in logic design interface 780 represents five elementary time units. The length of the time-lines for the qubits in logic design interface 780 can be controlled by length button 782.

The teleportation circuit illustrated in logic design interface 780 includes readout operations on qubits Q1 and Q2. If the value resulting from the respective readout operation yields a |1>, then a further gate is applied to the target qubit Q3 (FIG. 8A). For example, referring again to FIG. 8A, the X and Z logic gates applied to qubit Q1 are conditional operations based on the value of the readout operations executed on qubits Q1 and Q2. If the readout operation on qubit Q2 results in a value of |1>, then the X operation is applied to qubit Q1, and if the readout operation on qubit Q1 results in a value of |1>, then the Z operation is applied on qubit Q1. These conditional operations are achieved in the quantum circuit illustrated FIG. 8A by selections made in conditions option on drop-down menu 781. In an embodiment of the invention, conditions option on drop-down menu 781 will only appear when the user has opened drop-down menu 781 on a readout operation. Conditional operations in quantum circuits in the present invention are described in detail in Section 5.2, above.

FIG. 8B illustrates the ground conditionals interface 782, where any form of classical logic can be applied to the outcome of the readout operation. For example, the statement illustrated in FIG. 8B reads in pseudo-code:

If (Ground on qubit Q2 at time unit 5 results in |1>),

then (apply X operation on qubit Q3 at time unit 6).

FIG. 8C illustrates an embodiment of the control statement browser interface 783, where a user can view the conditional logic statements that are applied for the respective quantum circuit. Referring to the quantum circuit illustrated in FIG. 8A, an embodiment of the invention includes two conditional operations each based on the readout operations on qubit Q1 and Q2, respectively, which are illustrated in FIG. 8C as cond1 and cond2 in the left hand panel. In an embodiment, when one of the conditionals of the respective circuit is selected, the conditional logic of that conditional appears in the main panel of control statement browser interface 783. FIG. 8C illustrates an example of the conditional logic for cond2 from the teleportation circuit illustrated in FIG. 8A.

FIG. 9A illustrates an embodiment of run mode interface 800 (FIG. 1, output module 56) that includes run console interface 835, final states interface 891, OS interface 892, and state magnitude interface 893. Run mode interface 800 is an embodiment of the output results interface, illustrated as element 208 in FIG. 2, used to display the execution of quantum logic. In an embodiment, run console interface 835 acts as the main control interface for displaying and reviewing the execution of a calculation. Run console interface 835 can include a plot views panel 835-1, for displaying various output interfaces, and a time controls panel 835-2, for controlling the position of a time cursor that aids in viewing and understanding the output results. Both state magnitudes interface 893 and final states interface 891 are embodiments of interfaces for viewing the results of execution of the quantum logic, whereas OS interface 892 is useful for comparing the results against the input pulses or machine language of the logic.

In some embodiments of the present invention, final states interface 891 (FIG. 9A) includes three components: (i) the initial state of quantum register 72, (ii) the value of quantum register 72 at the time cursor, and (iii) the final state of quantum register 72 after the calculation. Changing the position of the time cursor will change the corresponding information stored in quantum register 72. This intermediate value is useful for tracking the quantum logic through execution. State magnitude interface 893 provides a graphical representation of the information in quantum register 72 in the form of a plot of state population versus time. The output illustrated in FIG. 9A in state magnitude interface 893 illustrates an example of a quantum CNOT operation applied between two qubits having an arbitrary initial state. Tracing state lines in state magnitude interface 893 demonstrates that states 893-01 and 893-11, corresponding to quantum states |01> and |11> respectively, exchange probabilities, whereas the states 893-00 and 893-10, corresponding to quantum states |00> and |10> respectively, do not change in probability. This demonstrates the CNOT logic where the control qubit is Q1 and the target qubit is Q2 such that the state is represented as |Q2 Q1|.

FIG. 9B illustrates another embodiment of run mode interface 800. The run mode interface 800 of FIG. 9B illustrates an example of output from a quantum teleportation circuit, such as that illustrated logic design interface 780 of FIG. 8A. Run mode interface 800 (FIG. 9B) includes final states interface 891-1 and intermediate states interface 891-2, which are similar to final states interface 891 illustrated in FIG. 9A. Final states interface 891-1 and intermediate states interface 891-2 include final global phase panels 891-1-P and 891-2-P, respectively, which apply a global phase defined by the user to the final state of the quantum register. For example, intermediate states interface illustrates a global phase of e^{iπ/2}, where the number 1.570796 can be entered by the user and in this example represents π/2, having been applied to the final state of the quantum register, allowing the final output to take the same form as the initial state of the quantum register. In the example of the teleportation circuit illustrated in FIG. 8A, the state information stored in qubit Q1 is transferred to qubit Q3, where the state is represented by |Q3 Q2 Q1>. In an example of the teleportation circuit the final states of qubit Q1 and qubit Q2 are not important.

The present invention can be implemented as a computer program product that includes a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave. The software modules in the computer program product may also be distributed by hardcopy printout or other means.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

We claim:

1. A computer program product for use in conjunction with a computer system, the computer program product comprising a computer readable storage medium and a computer program mechanism embedded therein, the computer program mechanism comprising:
a quantum computing integrated development environment (QC-IDE) module for designing quantum logic for a plurality of qubits, the QC-IDE module including instructions for generating a time resolved set of operators; and
a compiler module for compiling quantum logic, the compiler module including instructions for compiling said time resolved set of operators into a set of quantum machine language instructions.

2. The computer program product of claim 1, wherein said set of quantum machine language instructions includes a set of hardware executable instructions, wherein at least one instruction in said set of hardware executable instructions can only be executed on a quantum computer.

3. The computer program product of claim 2, wherein said set of quantum machine language instructions further includes instructions executable on a conventional computer.

4. The computer program product of claim 1, wherein said time resolved set of operators includes a sequence of fundamental operators.

5. The computer program product of claim 4, wherein said sequence of fundamental operators includes all possible unitary transformations for a predetermined quantum computer.

6. The computer program product of claim 5, wherein said predetermined quantum computer is a quantum system that is capable of executing each operator in a universal set of unitary operators.

7. The computer program product of claim 4, wherein said sequence of fundamental operators is described by a unitary 2^{N} by 2^{N} matrix, wherein N is a number of qubits in said quantum computer that is used to execute said fundamental operator.

8. The computer program product of claim 4, wherein a fundamental operator in said sequence of fundamental operators is represented by the unitary matrix
$${\hat{σ}}_{X} = [ \begin{matrix}0 & 1 \\ 1 & 0\end{matrix} ] .$$

9. The computer program product of claim 4, wherein a fundamental operator in said sequence of fundamental operators is represented by the unitary matrix
$${\hat{σ}}_{Z} = [ \begin{matrix}1 & 0 \\ 0 & - 1\end{matrix} ] .$$

10. The computer program product of claim 4, wherein a fundamental operator in said sequence of fundamental operators is represented by the unitary matrix
$${\hat{σ}}_{y} = [ \begin{matrix}0 & - i \\ i & 0\end{matrix} ] .$$

11. The computer program product of claim 4, wherein a fundamental operator in said sequence of fundamental operators applies to a single qubit in said quantum computer.

12. The computer program product of claim 4, wherein a fundamental operator in said sequence of fundamental operators applies to a plurality of qubits.

13. The computer program product of claim 1, wherein the QC-IDE module further includes instructions for defining a sequence of fundamental quantum gates as a single abstract quantum gate that is included in said time resolved set of operators.

14. The computer program product of claim 1, wherein the QC-IDE module includes instructions for defining a sequence of abstract quantum gates as a single abstract quantum gate that is included in said time resolved set of operators.

15. The computer program product of claim 1, wherein the QC-IDE module includes instructions for setting driver specifications of a quantum computer.

16. The computer program product of claim 1, wherein the QC-IDE module includes instructions for setting the frequency of a fundamental operator in said time resolved set of operators.

17. The computer program product of claim 16, wherein said instructions for setting the frequency of a fundamental operator in said time resolve set of operators further comprises:
instructions for setting the sharpness of each pulse in said fundamental operator; and
instructions for setting the amplitude of each pulse in said fundamental operator.

18. The computer program product of claim 1, wherein the QC-IDE module includes instructions for independently setting the frequency of each fundamental operator in said time resolved set of operators.

19. The computer program product of claim 1, wherein the QC-IDE module includes for selecting a quantum computing system to execute all or a portion of said set of quantum machine language instructions.

20. The computer program product of claim 1, wherein said QC-IDE module includes instructions for defining a quantum computing system.

21. The computer program product of claim 20, wherein said instructions for defining a quantum computing system includes instructions for specifying a set of fundamental operations that can be executed by said quantum computing system.

22. The computer program product of claim 20, wherein said instructions for defining a quantum computing system includes instructions for specifying the noise in said quantum computing system.

23. The computer program product of claim 20, wherein said instructions for defining a quantum computing system includes instructions for defining driver specifications for said quantum computing system.

24. The computer program product of claim 1, wherein said QC-IDE module includes instructions for converting abstract quantum gates in said time resolved set of operators to a sequence of fundamental operators.

25. The computer program product of claim 24, wherein said instructions for converting use a set of simplification rules.

26. The computer program product of claim 25, wherein a simplification rule in said set of simplification rules is a commutation of a fundamental operators.

27. The computer program product of claim 25, wherein a simplification rule in said set of simplification rules is removal of a redundancy between a first fundamental operator and a second fundamental operator.

28. The computer program product of claim 24, wherein said instructions for converting includes instructions for representing an abstract operator in said time resolved set of operators as an equivalent sequence of fundamental operators.

29. A method for quantum computing, the method comprising:
designing quantum logic for a plurality of qubits, wherein said designing includes generating a time resolved set of operators; and
compiling said time resolved set of operators into a set of quantum machine language instructions.

30. The method of claim 29 wherein said method further comprises
executing the quantum machine language instructions on a quantum computing system; and
outputting results of the execution of the quantum machine language instructions.

31. The method of claim 29 wherein said quantum machine language instructions model a quantum system.

32. The method of claim 31 wherein said quantum system is a many-body electron system, nuclear fusion, nuclear fission, a protein in solution, a nucleic acid in solution, or the interact between a macromolecule and an organic compound.

33. A computer program product for use in conjunction with a computer system, the computer program product comprising a computer readable storage medium and a computer program mechanism embedded therein, the computer program mechanism comprising:
a quantum computing integrated development environment (QC-IDE) module for designing quantum logic for a plurality of qubits, the QC-IDE module including instructions for generating a time resolved set of operators; and
a compiler module for compiling quantum logic, the compiler module including instructions for compiling said time resolved set of operators into a set of quantum machine language instructions.

34. A computer system for designing quantum logic, the computer system comprising:
a central processing unit;
a memory, coupled to the central processing unit, the memory storing a quantum computing integrated development environment (QC-IDE) module and a compiler module;
the quantum computing integrated development environment (QC-IDE) module including instructions for generating a time resolved set of operators; and
the compiler module including instructions for compiling said time resolved set of operators into a set of quantum machine language instructions.
